(19) United States
(12) Patent Application Publication
(10) Pub. No.: US 2005/0120334 A1
(43) Pub. Date: Jun. 2, 2005

(54) Method for competitive peer programming

(75) Inventor: Timothy G. Deboer, Toronto (CA)

Correspondence Address: Mark S. Walker;International Business Machines, Intellectual Property Law, 11400 Burnet Road, Austin, TX, 78758, US

(73) Assignee: INTERNATIONAL BUSINESS MACHINES CORPORATION, ARMONK, NY (US)

(21) Appl. No.: 10/798,915

(22) Filed: Mar. 11, 2004

(30) Foreign Application Priority Data
Nov. 27, 2003 (CA) 2451253

(51) Int. Cl. G06F 9/44

(52) U.S. Cl. 717/120; 717/110

(57) ABSTRACT

A method for competitive peer programming provides for multiple software developers to make changes to a common body of source code concurrently. A first developer makes changes to a section of source code resulting in modified code. The modified code is made accessible to other developers. The modified code is tested and a test result is compared with a reference test result. Based on the comparison a second developer can choose to change a section of source code thereby replacing the modified code. The steps of making the modified code accessible, testing the modified code, comparing the test results and determining if further changes are desired can be repeated any number of times with the first and second developers exchanging roles. The method according to the present invention enables improved interactions between multiple software developers and enables multiple developers to work on a section of source code concurrently.

### FIELD OF INVENTION

The present invention relates to the field of software development. In particular, to software development involving multiple software developers that interact via a common development environment.

### BACKGROUND

As software applications become larger and more complex the use of teams of software developers for the development of the software has become common place. Challenges arise when multiple software developers work concurrently on (i.e. develop) the same body of software source code. Multi-user software development systems and environments have been created that address some of these challenges by providing central/shared source code repositories, version control functions, access control functions, software load built management functions, test management functions and other similar capabilities. Although these systems and environments mitigate the impact of some of the challenges of multiple concurrent developers, most operate in a paradigm in which each of the multiple developers works largely autonomously. Interaction between developers is often restricted to each developer independently making changes to a section of the source code, each developer checking a completed changed section of code into a source code repository, when all changes to section of code are completed building of a new software load incorporating all of the changed sections of code, then each developer downloads the new software load and assess the aggregate impact of (i.e. tests) the changes made by the other developers on his or her own work product (i.e. changed section of code). If necessary, each developer then makes further changes and the cycle is repeated. This approach to team-based (i.e. joint) software development is often inefficient as it requires the coordination of completion of the changes to the section of code by all of the developers and does not lend itself to having multiple developers working on the same section of the source code concurrently.

What is needed is a software development method that enables improved interaction between members of a software development team and enables multiple developers to work on a section of source code concurrently.

### SUMMARY OF INVENTION

A method according to the present invention provides for multiple software developers to work on a common body of source code concurrently. For example, each of a first and a second developer can start with the same version of a section of the source code. When the first developer has completed making changes to the section of source code the resulting modified section of code can be made accessible to the second developer by, for example, being placed on a team server. The modified section of code is tested thereby producing a test result. The test result is compared to a reference test result. The reference test result can be produced, for example, from the testing of another modified section of code which is the result of changes made to the section of code by the second developer or from a pre-modified version of the section of code. Based on the comparison of the test result with the reference test result, the second developer can determine that the changes made by the first developer have resulted in a preferred test result. The second developer can then choose to make additional changes to the section of code producing another modified section of code and when the additional changes are completed the steps of the method can be repeated with the roles of the first and the second developers being reversed. Thus each of the developers can periodically evaluate their work product against that of other developers and thereby determine if further improvements (i.e. changes to the source code) are required. The method provides for the evaluation and comparison of multiple implementations of (i.e. changes to) a section of source code.

In an alternative scenario using a method according to the present invention, the method is similar to the method described above however sections of source code to which the first and the second developers make changes are not the same section of source code. Preferably the sections of code are ones that are in some way inter-dependent or that interact during execution of the corresponding executable code. Each developer can assess the impact of changes made by the other developer as modified sections of code become accessible and are tested. This provides for the incremental assessment of the impact of changes to sections of source code made by developers as the changes are completed and does not necessitate the co-ordination of the completion of changes by multiple developers and the commonly practice of mass testing and evaluation of multiple changes concurrently. The method according to the present invention provides for testing of changes made, by a developer, to a section of source code as the changes are completed, for assessment of the impact of the changes on the work product of other developers and for reaction to the changes by other developers in the form of other changes to sections of the source code.

It will be understood that the methods described above and herein after using scenarios with two developers apply equally to scenarios having more than two developers while remaining within the spirit and scope of the present invention.

In accordance with one aspect of the present invention, a method for competitive peer programming in an environment where each of a first and a second developer can make changes to any of a plurality of sections of source code comprising the steps of: a) enabling said first developer to make changes to a first section of source code thereby producing a modified section of code; b) providing access to said modified section of code; c) enabling testing of said modified section of code to produce a test result; d) enabling comparison of said test result with a reference test result; and e) based on the comparison of step d), enabling said second developer to make changes to a second section of source code thereby replacing said modified section of code and repeating steps b) through e) with said first and said second developers exchanging roles, until said comparison indicates no further changes are required.

In accordance with another aspect of the present invention, a computer program product for competitive peer programming in an environment where each of a first and a second developer can make changes to any of a plurality of sections of source code, the computer program product comprising computer readable program code devices for: a) enabling said first developer to make changes to a first section of source code thereby producing a modified section of code; b) providing access to said modified section of code; c) enabling testing of said modified section of code to produce a test result; d) enabling comparison of said test result with a reference test result; and e) based on the comparison of step d), enabling said second developer to make changes to a second section of source code thereby replacing said modified section of code and repeating steps b) through e) with said first and said second developers exchanging roles, until said comparison indicates no further changes are required.

In accordance with still another aspect of the present invention, a method for competitive peer programming in an environment where each of a first and a second developer can make changes to any of a plurality of sections of source code comprising the steps of: a) making changes to a first section of source code thereby producing a modified section of code, wherein said changes are made by said first developer; b) accessing said modified section of code; c) testing said modified section of code to produce a test result; d) comparing said test result with a reference test result; and e) based on the comparison of step d), making changes to a second section of source code thereby replacing said modified section of code, wherein said changes are made by said second developer, and repeating steps b) through e) with said first and said second developers exchanging roles, until said comparison indicates no further changes are required. Other aspects and features of the present invention will become apparent to those ordinarily skilled in the art upon review of the following description of specific embodiments of the invention in conjunction with the accompanying figures.

### BRIEF DESCRIPTION OF DRAWINGS

The present invention will be described in conjunction with the drawings in which:

FIG. 1 is a schematic representation of an exemplary development environment in which a method according to the present invention can be used.

FIG. 2 is a flow diagram representing the steps in an exemplary method according to the present invention.

FIG. 3 is a schematic representation of an exemplary generic computing platform on which the present invention can be practiced.

### DETAILED DESCRIPTION

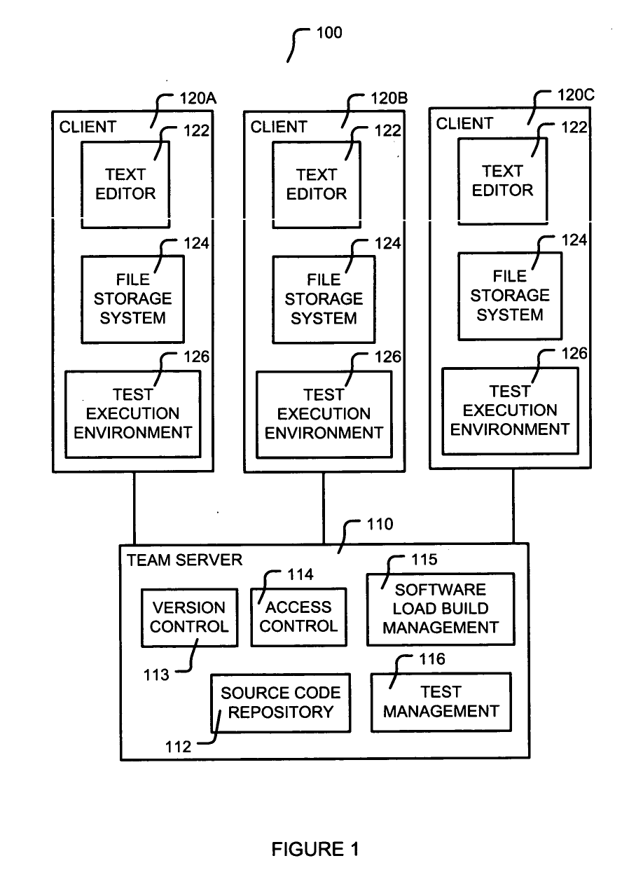

FIG. 1 is a schematic representation of an exemplary software development environment 100 in which a method according to the present invention can be practiced. The software development environment 100 comprises a team server 110 and a plurality of client machines 120A-C. The team server 110 provide software development related functions including a central/shared source code repository 112, a version control function 113, an access control function 114, a software load built management function 115 and a test management function 116. Each of the client machines 120A-C is a computing platform suitable for use by a software developer and includes functions such as a text editor 122, a file storage system 124, a test execution environment 126 and other similar software development functions. A copy of the body of source code representing the software under development, know as the source code library, is stored on the team server 110. A software developer can access the source code library from one of the plurality of client machines, for example, 120A. A section of the source code in the library can be checked out of the library and a local copy of the section can be made on the client machine 120A. The software developer can make changes to the local copy stored on the client machine 120A. When the software developer is satisfied with the changes made to the local copy, a resulting modified section of source code can be checked in to the library on the team server 110. Thereafter the modified section of the source code is visible to and accessible by other software developers such as those working on client machines 120B-C. Similarly, each of the developers working at client machines 120B-C can check out a section of source code, modify it and check a resulting modified section of code back into the team server 110 where it will be visible to and accessible by the software developers working at each of the other client machines 120A-C. Any number of the software developers can be operating concurrently on the source code as described above.

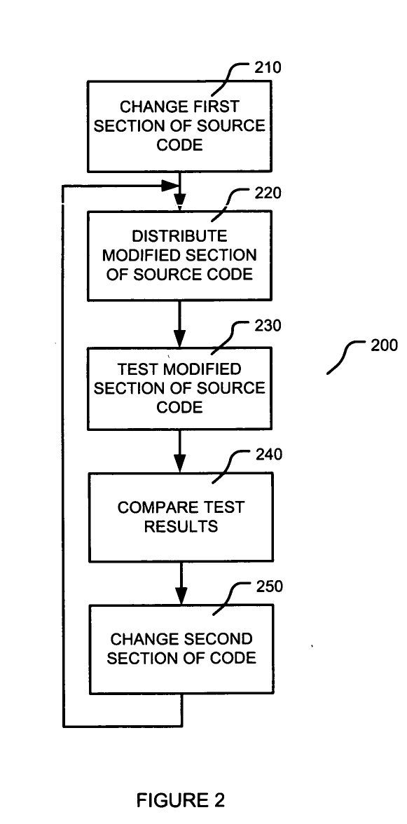

FIG. 2 represents the steps of an exemplary embodiment of a method 200 according to the present invention as carried out in the environment 100 of FIG. 1. The method begins when a software developer working at a client machine such as, for example, the software developer working at client machine 120A (therein after client A) changes a section of the source code 210 in the library on the team server 110. The step 210 of changing the section of source code includes sub-steps of checking out of the section of source code from the library, modifying or editing of the section of source code and checking in of a resulting modified section of source code into the library. After client A changes the section of source code 210, the team server 110 can distribute the modified section of source code 220 to each of the other client machines 120B-C for use by a software developer using the client machine (therein after client B and client C respectively). Distribution 220 of the modified section of source code by the team server can be automatic (e.g. event or time period triggered) or manual (i.e. triggered by a demand from any of the client machines 120A-C).

Having received the distribution of the modified section of source code, each of the clients, for example client B, can test 230 the modified section of source code. Testing can be automated or can be conducted manually. A test regime is applied that measures one or more aspects of the performance of the modified section of source code. Preferably the applied test regime results in a quantifiable outcome. However a test regime can be applied which results in a qualitative outcome while still remaining within the scope of the present invention. In an alternative embodiment of the present invention, testing of the modified section of source code can occur on the team server 110 with the results being made available to client B. In order to test the modified section of source code it may be necessary to build an executable software load incorporating other sections of the source code obtained from the library on the team server 110. Building of the executable software load can occur on the client machine, for example 120B. In an alternative embodiment, an executable software load can be built on the team server 110 and distribution of the modified section of source code 220 can take the form of distribution of the executable software load incorporating the modified section of source code.

The results of testing the modified section of source code obtained in step 230 are then compared 240 with a reference test result. The reference test result can, for example, be for another version of the section of source code associated with the software developer using a client machine, for example client B. The version of the section of source code associated with client B can be a version that was changed by client B. In an alternative embodiment, the version of the section of source code associated with client B can be a version of the section of source code before it was modified by client A. Test results for the version of the section of source code associated with client B (i.e. the reference test result) can be obtained from a test regime applied on the client machine 120B. In a further alternative embodiment, the test regime for the version of the section of source code associated with client B can be applied on the team server 110 and the results made available to client B.

Based on the comparison of the test results in step 240, client B may determine that the modified section of source code produced by client A is superior or in some way preferable to the version of the section of source code associated with client B. As a result Client B can make changes to the section of source code 250. The step of client B changing the section of source code 250 has sub-steps similar to those described previously for client A changing the section of code in step 210.

After client B has changed the section of source code and replaced the modified section of code in step 250, steps 220, 230 and 240 are executed substituting client B for client A and vise versa.

Steps 250, 220, 230 and 240 can repeated any number of times with clients A and B reversing (exchanging) roles as desired. For each repetition of the above described sequence of steps, the method can be terminated after the step of comparing the test results 240 when the comparison indicates that no further changes are required.

A method according to the present invention can be applied to a scenario with more than two concurrent software developers while remaining within the spirit and scope of the present invention. In the case with more than two concurrent software developers, the above described methods can be applied to any two of the developers in a pair-wise fashion. The section of source code to which each developer makes changes can be the same or a different section of source code.

A method according to the present invention can be implemented by a computer program product comprising computer readable program codes devices.

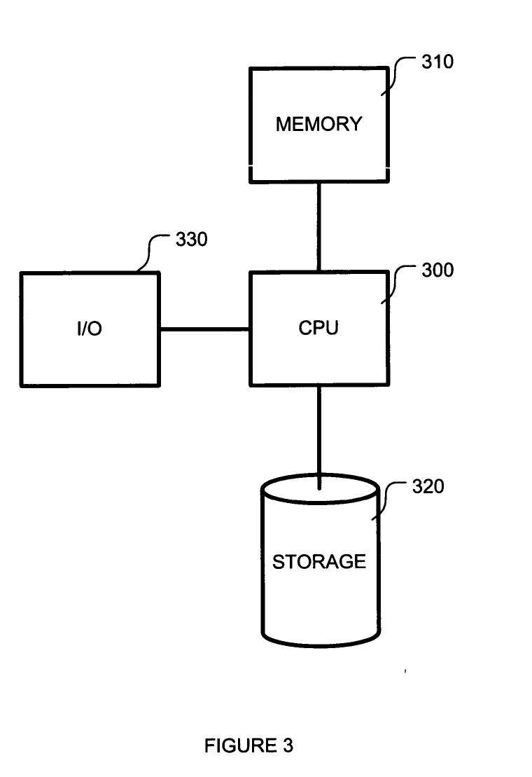

FIG. 3 is a schematic representation of an exemplary generic computing platform on which the present invention can be practiced. A central processing unit (CPU) 300 provides main processing functionality. A memory 310 is coupled to CPU 300 for providing operational storage of programs and data. Memory 310 can comprise, for example, random access memory (RAM) or read only memory (ROM). Non-volatile storage of, for example, data files and programs is provided by a storage device 320 that can comprise, for example, disk storage. Both memory 310 and storage device 320 comprise computer useable media that can store computer program products in the form of computer readable program code. User input and output is provided by an input/output (I/O) facility 330. The I/O facility 330 can include, for example, a graphical display, a mouse and a keyboard.

It will be apparent to one skilled in the art that numerous modifications and departures from the specific embodiments described herein may be made without departing from the spirit and scope of the present invention.

1. A method for competitive peer programming in an environment where each of a first and a second developer can make changes to any of a plurality of sections of source code comprising the steps of:
a) enabling said first developer to make changes to a first section of source code thereby producing a modified section of code;
b) providing access to said modified section of code;
c) enabling testing of said modified section of code to produce a test result;
d) enabling comparison of said test result with a reference test result; and
e) based on the comparison of step d), enabling said second developer to make changes to a second section of source code thereby replacing said modified section of code and repeating steps b) through e) with said first and said second developers exchanging roles, until said comparison indicates no further changes are required.

2. The method of claim 1, wherein said first section of source code and said second section of source code are different sections.

3. The method of claim 1, wherein said first section of source code and said second section of source code are the same section.

4. The method of claim 1, wherein said reference test result is produced from a version of said first section of source code before said changes were made.

5. The method of claim 1, wherein said reference test result is produced from a version of said second section of source code before said changes are made.

6. The method of claim 1, wherein a third developer can make changes to any of a plurality of sections of source code and steps b) through e) are executed separately with said second developer being replaced by said third developer.

7. A computer program product for competitive peer programming in an environment where each of a first and a second developer can make changes to any of a plurality of sections of source code, the computer program product comprising:
computer readable program code devices for:
a) enabling said first developer to make changes to a first section of source code thereby producing a modified section of code;
b) providing access to said modified section of code;
c) enabling testing of said modified section of code to produce a test result;
d) enabling comparison of said test result with a reference test result; and
e) based on the comparison of step d), enabling said second developer to make changes to a second section of source code thereby replacing said modified section of code and repeating steps b) through e) with said first and said second developers exchanging roles, until said comparison indicates no further changes are required.

8. The computer program product of claim 7, wherein said first section of source code and said second section of source code are different sections.

9. The computer program product of claim 7, wherein said first section of source code and said second section of source code are the same section.

10. The computer program product of claim 7, wherein said reference test result is produced from a version of said first section of source code before said changes are made.

11. The computer program product of claim 7, wherein said reference test result is produced from a version of said second section of source code before said changes are made.

12. The computer program product of claim 7, wherein a third developer can make changes to any of a plurality of sections of source code and steps b) through e) are executed separately with said second developer being replaced by said third developer.

13. A method for competitive peer programming in an environment where each of a first and a second developer can make changes to any of a plurality of sections of source code comprising the steps of:
a) making changes to a first section of source code thereby producing a modified section of code, wherein said changes are made by said first developer;
b) accessing said modified section of code;
c) testing said modified section of code to produce a test result;
d) comparing said test result with a reference test result; and
e) based on the comparison of step d), making changes to a second section of source code thereby replacing said modified section of code, wherein said changes are made by said second developer, and repeating steps b) through e) with said first and said second developers exchanging roles, until said comparison indicates no further changes are required.

14. The method of claim 13, wherein said first section of source code and said second section of source code are different sections.

15. The method of claim 13, wherein said first section of source code and said second section of source code are the same section.

16. The method of claim 13, wherein said reference test result is produced from a version of said first section of source code before said changes were made.

17. The method of claim 13, wherein said reference test result is produced from a version of said second section of source code before said changes are made.

18. The method of claim 13, wherein a third developer can make changes to any of a plurality of sections of source code and steps b) through e) are executed separately with said second developer being replaced by said third developer.
